(19) United States
(12) Patent Application Publication
(10) Pub. No.: US 2011/0136720 A1
(43) Pub. Date: Jun. 9, 2011

(54) METHOD FOR IMPROVING THE CLEANING ACTION OF A DETERGENT OR CLEANING AGENT

(75) Inventors: Timothy O'Connell, Dusseldorf (DE); Petra Siegert, Haan (DE); Karl-Heinz Maurer, Erkrath (DE); Marc-Steffen Schiedel, Dusseldorf (DE); Inga Kerstin Vockenroth, Dusseldorf (DE)

(73) Assignee: HENKEL AG & CO. KGaA, Dusseldorf (DE)

(21) Appl. No.: 13/026,344

(22) Filed: Feb. 14, 2011

Related U.S. Application Data
(63) Continuation of application No. PCT/EP2009/058791, filed on Jul. 10, 2009.

(30) Foreign Application Priority Data
Aug. 20, 2008 (DE) 10 2008 038 479.8

(51) Int. Cl. C11D 3/386

(52) U.S. Cl. 510/321; 510/320

(57) ABSTRACT

A washing or cleaning process includes the step of preparing a washing or cleaning solution that includes a washing or cleaning agent including a hydrolytic enzyme, and a component that, by interacting with the hydrolytic enzyme when the agent is used, affects a synergistic cleaning power. The component may be an anionic and/or polyanionic substance, a cationic and/or polycationic substance, and/or a substance that possesses hydroxyl and/or polyhydroxyl group(s). The process then includes the step of contacting a textile or a hard surface with the washing or cleaning solution.

### CROSS-REFERENCES TO RELATED APPLICATIONS

This is a continuation of International Application No. PCT/EP2009/058791, filed Jul. 10, 2009, which claims priority to German Patent Application No. DE102008038479.8 filed Aug. 20, 2008, both of which are hereby incorporated by reference.

### FIELD OF THE INVENTION

The present invention generally relates to methods for improving the cleaning power of a washing or cleaning agent that comprises a hydrolytic enzyme.

### BACKGROUND OF THE INVENTION

The use of enzymes in washing and cleaning agents is established in the prior art. Commensurate with their specific activities, they serve to broaden the performance spectrum of the agent in question. In particular they include hydrolytic enzymes such as proteases, amylases, lipases and cellulases. The first three enzymes hydrolyze proteins, starches and fats and therefore contribute directly to soil removal. Cellulases are added particularly for their action on tissues. Another group of enzymes for washing and cleaning agents is oxidative enzymes, especially oxidases, which, optionally in conjunction with other components, preferably serve to bleach stains or to generate the bleaching agent in situ. Besides these enzymes, which are the subject of a continuous optimization, additional enzymes are continually being provided for use in washing and cleaning agents, especially in order to be able to target specific stains in an optimal manner such as, for example pectinases, β-glucanases, mannanases or further hemicellulases for in particular, hydrolyzing specific vegetal polymers.

The enzymes that are contained in the longest established—and in practically all modern, efficient washing and cleaning agents—are proteases and among these especially serine-proteases, which also include the subtilases. They decompose protein-containing stains on the articles to be cleaned. Among these, proteases of the subtilisin type (subtilases, subtilopeptidases, EC 3.4.21.62) are again particularly important and are classified as serine proteases, owing to the catalytically active amino acids. They act as unspecific endopeptidases, i.e. they hydrolyze any acid amide bonds located inside peptides or proteins. Their pH optimum is usually within the distinctly alkaline range. A review of this family is provided, for example, by the paper “Subtilases: Subtilisin-like Proteases” by R. Siezen, pages 75-95 in “Subtilisin enzymes”, edited by R. Bott and C. Betzel, New York, 1996. Subtilases are naturally formed by microorganisms; among these, as the most important group among the subtilases, may be mentioned the subtilisins formed and secreted by Bacillus species.

Examples of the proteases of the subtilisin type that are preferably used in washing and cleaning agents are the subtilisins BPN′ and Carlsberg, the protease PB92, the subtilisins 147 and 309, the alkaline protease from Bacillus lentus, in particular from Bacillus lentus DSM 5483, subtilisin DY and those enzymes of the subtilases no longer however classified in the stricter sense as subtilisins thermitase, proteinase K and the proteases TW3 and TW7. Further useable proteases are, for example, those enzymes available with the trade names Durazym®, Relase®, Everlase®, Nafizym, Natalase®, Kannase® and Ovozyme® from the Novozymes Company, those under the trade names Purafect®, Purafect® OxP, Purafect® Prime and Properase® from Genencor, that under the trade name Protosol® from Advanced Biochemicals Ltd., Thane, India, that under the trade name Wuxi® from Wuxi Snyder Bioproducts Ltd., China, those under the trade names Proleather® and Protease P® from Amano Pharmaceuticals Ltd., Nagoya, Japan, and that under the designation Proteinase K-16 from Kao Corp., Tokyo, Japan.

At best, synergistic effects result between the enzymes and the usual ingredients of the washing and cleaning agent in question.

In the prior art, a disadvantage of these preferred enzymes for use in washing and cleaning agents, especially proteases, is that especially at low temperatures, for example between 10° C. and 40° C., in particular between 10° C. and 30° C. or even between 10° C. and 25° C., they do not have a satisfactory hydrolytic activity, especially proteolytic activity, and therefore do not exhibit optimal cleaning power, particularly in washing agents and dishwasher detergents in this temperature range.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

It has surprisingly been found that the addition of certain substances considerably improves the cleaning power of washing and cleaning agents that comprise hydrolytic enzymes, particularly proteases, in particular at comparatively low temperatures, especially between 10° C. and 50° C., between 10° C. and 40° C. and preferably between 10° C. and 30° C. or 10° C. and 25° C.

Accordingly, the present invention is based on the object of improving the cleaning power (washing power) of washing or cleaning agents, especially in regard to stains that are sensitive towards decomposition by hydrolytic enzymes, especially by proteases. Another object of the invention is to improve the cleaning power of hydrolytic enzymes, especially proteases, in washing or cleaning agents or in the washing liquor formed by the washing or cleaning agent, especially in regard to stains that are sensitive towards decomposition by hydrolytic enzymes, especially by proteases, and especially in a temperature range between 10° C. and 50° C., between 10° C. and 40° C. and preferably between 10° C. and 30° C. or 10° C. and 25° C.

Accordingly, the subject matter of the invention is a process for improving the cleaning power of a washing or cleaning agent that comprises a hydrolytic enzyme, in particular a protease, amylase, cellulase, hemicellulase, mannanase, tannase, xylanase, xanthanase, β-glucosidase, carrageenase or a lipase, particularly preferably a protease, wherein a component is added to the washing or cleaning agent which, in acting together with the hydrolytic enzyme when the agent is used, effects a synergistic cleaning power, and which is selected from

i. an anionic and/or polyanionic substance, and/or

ii. a cationic and/or polycationic substance, and/or

iii. a substance that possesses hydroxyl and/or polyhydroxyl group(s).

It was inventively established that the cleaning power of washing or cleaning agents, in particular in regard to their enzymatic, especially proteolytic cleaning power, is significantly improved when at least one hydrolytic enzyme (herein also referred to as component (a)) is combined in these agents with one or more of the substances or classes of substances listed under i. to iii. (herein also referred to as component (b)). In the context of the invention, “cleaning power” is understood to mean the brightening power on one or more stains, especially washing stains, which are sensitive towards degradation by the hydrolytic enzyme in question, in particular towards the degradation by proteases. Examples of such stains are blood-milk/ink on cotton, whole egg/pigment on cotton, chocolate-milk/ink on cotton, peanut oil-pigment/ink on polyester/cotton, grass on cotton or cocoa on cotton, especially of the type listed below. In the context of the invention, not only the washing or cleaning agent that comprises the hydrolytic enzyme or the wash or cleaning liquor formed by this agent, but also the hydrolytic enzyme itself, have a cleaning power. Therefore the cleaning power of the hydrolytic enzyme contributes to the cleaning power of the agent and the wash or cleaning liquor formed by the agent.

The cleaning power of washing and cleaning agents based on the added enzymatic activity, in particular on the proteolytic activity, is improved by the addition of the component (b). In regard to the interaction of these components (a) and (b), there results a synergistic effect, i.e. a better performance in comparison to the individual performances of each of the components in one-component systems (i.e. washing or cleaning agents that at any one time comprise only the hydrolytic, in particular the proteolytic enzyme, or the component (b)) and also to the sum of the individual performances of the components (a) and (b), i.e. the sum of two one-component systems each having the components (a) and (b) alone. Consequently, the selected combination of the hydrolytic enzyme (a), in particular the protease, with an inventive component (b) represents a further possibility for improving the efficiency of washing or cleaning agents in regard to their cleaning power, in particular their enzyme-based cleaning power, quite particularly in regard to their cleaning power that is caused by the presence of a protease.

The advantageousness of the combination of the components (a) and (b) is available when using the agent, i.e. in the washing or cleaning liquor. “Washing or cleaning liquor” is understood to mean that solution comprising the washing or cleaning agent which acts on textiles or fabrics (washing liquor) or on hard surfaces (cleaning liquor), and thereby comes into contact with the stains that are present on the textiles and/or fabrics or hard surfaces. The washing or cleaning liquor usually comes into being when the washing or cleaning process begins and the washing or cleaning agent is dissolved or diluted with water, for example in a washing machine or in another suitable container.

In the context of the component (a), preferred hydrolytic enzymes particularly comprise proteases, amylases, in particular α-amylases, cellulases, lipases, hemicellulases, in particular pectinases, mannanases, β-glucanases, as well as their mixtures. Proteases, amylases and/or lipases as well as their mixtures are particularly preferred, proteases being quite particularly preferred. In principle, these enzymes are of natural origin; improved variants based on the natural molecules are available for use in laundry detergents or cleaning compositions and accordingly they are preferred.

Preferred proteases are those of the subtilisin type. Examples of these are subtilisins BPN′ and Carlsberg, the protease PB92, the subtilisins 147 and 309, the alkaline protease from Bacillus lentus, subtilisin DY and those enzymes of the subtilases no longer however classified in the stricter sense as subtilisins thermitase, proteinase K and the proteases TW3 and TW7. Subtilisin Carlsberg in further developed form is available under the trade name Alcalase® from Novozymes A/S, Bagsvwrd, Denmark. Subtilisins 147 and 309 are commercialized under the trade names Esperase® and Savinase® by the Novozymes company. The variants sold under the name BLAP® are derived from the protease from Bacillus lentus DSM 5483. Further useable proteases are, for example, those enzymes available with the trade names Durazym®, Relase®, Everlase®, Nafizym®, Natalase®, Kannase® and Ovozyme® from the Novozymes Company, those under the trade names Purafect®, Purafect® OxP, Purafect® Prime, Excellase® and Properase® from Genencor, that under the trade name Protosol® from Advanced Biochemicals Ltd., Thane, India, that under the trade name Wuxi® from Wuxi Snyder Bioproducts Ltd., China, those under the trade names Proleather® and Protease P® from Amano Pharmaceuticals Ltd., Nagoya, Japan, and that under the designation Proteinase K-16 from Kao Corp., Tokyo, Japan. The proteases from Bacillus gibsonii and Bacillus pumilus, which are disclosed in the international patent applications WO2008/086916 and WO2007/131656, are particularly preferably employed.

Examples of amylases that can be used according to the invention are the α-amylases from Bacillus licheniformis, from B. amyloliquefaciens or from B. stearothermophilus, as well as their improved further developments for use in washing or cleaning agents. The enzyme from B. licheniformis is available from the Novozymes Company under the name Termamyl® and from the Genencor Company under the name Purastar®ST. Further development products of this α-amylase are available from the Novozymes Company under the trade names Duramyl® and Termamyl®ultra, from the Genencor Company under the name Purastar®OxAm and from Daiwa Seiko Inc., Tokyo, Japan as Keistase®. The α-amylase from B. amyloliquefaciens is commercialized by the Novozymes Company under the name BAN®, and derived variants of the α-amylase from B. stearothermophilus under the names BSG® and Novamyl® also from the Novozymes Company. Moreover, for these purposes, attention should be drawn to the α-amylase from Bacillus sp. A 7-7 (DSM 12368) and the cyclodextrin-glucanotransferase (CGTase) from B. agaradherens (DSM 9948). Furthermore, the amylolytic enzymes are useable, which belong to the α-amylase sequence space, described in the international application WO 03/002711 A2 and those described in the application WO 03/054177 A2. Fusion products of the cited molecules can also be used. Moreover, further developments of α-amylase from Aspergillus niger and A. oryzae available from the Company Novozymes under the trade name Fungamyl® are suitable. Additional commercial products that can be used are for example the Amylase-LT® and Stainzyme® or Stainzyme ultra® or Stainzyme plus®, the last also from the Novozymes company. Variants of these enzymes obtained by point mutations can also be inventively incorporated.

Exemplary inventively useable lipases or cutinases that are comprised in particular due to their triglyceride-cleaving activities, but also to generate peracids in situ from appropriate precursors, are the lipases that are originally obtainable from Humicola lanuginose (Thermomyces lanuginosus) or further developed lipases, especially those with the amino acid exchange D96L. They are commercialized, for example by the Novozymes Company under the trade names Lipolase®, Lipolase® Ultra, LipoPrime®, Lipozyme® and Lipex®. Moreover, suitable cutinases, for example are those that were originally isolated from Fusarium solani pisi and Humicola insolens. Likewise useable lipases are available from the Amano Company under the designations Lipase CE®, Lipase P®, Lipase B®, and Lipase MC, Lipase AKG®, Bacillis sp. Lipase®, Lipase AP®, Lipase M-AP® and Lipase AML®. Suitable lipases or cutinases whose starting enzymes were originally isolated from Pseudomonas mendocina and Fusarium solanii are for example available from Genencor Company. Further important commercial products that may be mentioned are the commercial preparations M1 Lipase® and Lipomax® originally from Gist-Brocades Company, and the commercial enzymes from the Meito Sangyo KK Company, Japan under the names Lipase MY-30®, Lipase OF® and Lipase PLR as well as the product Lumafast® from the Genencor Company.

Cellulases can be present, depending on the purpose, as pure enzymes, as enzyme preparations or in the form of mixtures, in which the individual components advantageously complement each other in regard to their various performance aspects. Among these aspects of performance are particular contributions from the cellulase to the primary washing performance of the agent, to the secondary washing performance of the agent, (anti-redeposition activity or inhibition of graying), to the softening or brightening (effect on the fabric) or to carrying out a “stone washed” effect. A usable, fungal endoglucanase (EG)-rich cellulase preparation, or its further developments are offered by the Novozymes Company under the trade name Celluzyme®. The products Endolase® and Carezyme® based on the 50 kD-EG, respectively 43 kD-EG from H. insolens DSM 1800 are also obtainable from the Novozymes Company. Further useable commercial products from this company are Cellusoft®, Renozyme® and Celluclean®. It is also possible to use for example the 20 kD-EG from Melanocarpu, which is available under the trade names Ecostone® and Biotouch® from AB Enzymes, Finland. Further commercial products from the AB Enzymes Company are Econase® and Ecopulp®. Further suitable cellulases are from Bacillus sp. CBS 670.93 and CBS 669.93, the CBS 670.93 from Bacillus sp. being available under the trade name Puradax® from the Genencor Company. Other commercial products from the Genencor Company are “Genencor detergent cellulase L” and IndiAge® Neutra.

Additional enzymes, which are summarized under the term hemicellulases, can be incorporated, especially for removing specific problematic stains. These include, for example mannanases, xanthanlyases, pectinlyases (=pectinases), pectinesterases, pectatlyases, xyloglucanases (=xylanases), pullulanases und β-glucanases. In this regard, suitable enzymes are for example available under the names Gamanase® and Pektinex AR® from the Novozymes Company, under the names Rohapec® B1 L from AB Enzymes and under the names Pyrolase® from Diversa Corp., San Diego, Calif., USA. β-Glucanase, extracted from B. Subtilis, is available under the name Cereflo® from the Novozymes Company. Hemicellulases that are inventively particularly preferred are mannanases, e.g. those that are marketed for example under the tradenames Mannaway® from the Novozymes Company or Purabrite® from the Genencor Company.

In the context of the invention, the enzymes can moreover be conditioned together with concomitant substances, for example from the fermentation, or with stabilizers.

Among all these enzymes, those are particularly preferred, which are comparatively stable against oxidation or which have been stabilized for example by point mutagenesis. Among these are particularly the already mentioned commercial products Everlase and Purafect® OxP as examples of such proteases and Duramyl as an example of such an α-amylase.

The agents added in a process according to the invention preferably comprise enzymes in total quantities of 1×10-8 to 5 weight percent based on active protein. The agents comprise the enzymes preferably from 0.001 to 5 wt. %, more preferably from 0.01 to 5 wt. %, even more preferably from 0.05 to 4 wt. % and particularly preferably from 0.075 to 3.5 wt. %, wherein each comprised enzyme can be present in the cited amounts.

The protein concentration can be determined using known methods, for example the BCA Process (bicinchoninic acid; 2,2′-biquinolyl-4,4′-dicarboxylic acid) or the biuret process (A. G. Gornall, C. S. Bardawill and M. M. David, J. Biol. Chem., 177 (1948), pp. 751-766).

The hydrolytic enzyme, of which at least one (namely as the component (a)) is present in a washing or cleaning agent that is used in inventive processes, supports the cleaning power of the agent in regard to certain soils or stains. An agent used in a process according to the invention particularly preferably comprises a plurality of enzymes, wherein the enzymes can belong to the same or different classes of enzyme. The enzymes particularly preferably exhibit synergistic effects in regard to their action towards certain soils or stains, i.e. the enzymes comprised in the composition of the agent mutually support each other in their cleaning power.

Synergistic effects can exist not only between different enzymes, but also occur especially between one or a plurality of enzymes and additional ingredients of the agent that is used in the process according to the invention. For this, a hydrolytic enzyme (a) is inventively combined with a component (b), i.e. with at least one substance that in interacting with the hydrolytic enzyme (a) when the agent is used, effects a synergistic cleaning power, and which is selected from

i. an anionic and/or polyanionic substance, and/or

ii. a cationic and/or polycationic substance, and/or

iii. a substance that possesses hydroxyl and/or polyhydroxyl group(s).

The substances listed under i. concern anionic or polyanionic substances, i.e. these substances carry at least one and preferably a plurality of negative charges. They preferably concern a polymer containing at least one negatively charged monomer, preferably a plurality of negatively charged monomers. Accordingly, this inventively preferred polymer is a negatively charged polymer. Exemplary preferred are polymers of organic acids or their salts, especially polyacrylates and/or polysugar acids and/or polyacrylate copolymers and/or polysugar copolymers. In this regard, further preferred compounds are polyacrylic sulfonates or polycarboxylates and their salts, copolymers or salts of the copolymers.

Exemplary particularly preferably added substances are Acusol 587D (polyacrylic sulfonate; Rohm & Haas/Dow Chemical), Acusol 445N (polycarboxylate sodium salt; Rohm & Haas/Dow Chemical), Acusol 590 (polyacrylate copolymer; Rohm & Haas/Dow Chemical), Acusol 916 (polyacrylate sodium salt; Rohm & Haas/Dow Chemical), Sokalan CP42 (modified polycarboxylate sodium salt; BASF), Sokalan PA 30CL (polycarboxylate sodium salt; BASF), Dequest P 9000 (polymaleic acid; Thermphos), alginic acid, poly-2-acrylamido-2-methyl-1-propane sulfonic acid, poly-4-styrene sulfonic acid co-maleic acid sodium salt, polyacrylamide co-acrylic acid sodium salt, polymethacrylic acid sodium salt, polymethyl vinyl ether-alt-maleic acid or polyvinylsulfonic acid sodium salt.

The substances listed under ii. concern cationic or polycationic substances, i.e. these substances carry at least one and preferably a plurality of positive charges. They preferably concern a polymer containing at least one positively charged monomer, preferably a plurality of positively charged monomers. Accordingly, this inventively preferred polymer is a positively charged polymer. Exemplary preferred compounds in this regard are salts of the polyamines, polyethylene imines or their copolymers, salts of the polyallylamines, salts of the polydiallyldimethylammonium compounds or poly(acrylamide-co-diallyldimethylammonium compounds.

The substances listed under iii, concern substances that carry at least one hydroxyl and/or polyhydroxyl group and preferably possess a plurality of hydroxyl and/or polyhydroxyl groups. In this regard, polyvinyl alcohols, for example are preferred, for example those that are available under the trade name Mowiol (Kremer Pigmente GmbH & Co. KG).

At this point, it is expressly pointed out that an actual substance can belong to one or more of the previously cited groups i. to iii. For example it can concern an anionic polymer that possesses one or more hydroxyl and/or polyhydroxyl group(s). A substance of this type then belongs to the groups i and iii. Likewise, a cationic polymer that possesses one or more hydroxyl and/or polyhydroxyl group(s) belongs to the groups ii. and iii.

Derivatives of the previously cited substances that belong to i., ii. or iii. can also be inventively employed as the component (b). In the context of the present application, a derivative is understood to mean a substance that, starting from one of the previously cited substances, is chemically modified, for example by the conversion of a side chain or by covalently bonding another compound onto the substance. Such a compound can concern for example low molecular weight compounds such as lipids or mono-, oligo- or polysaccharides or amines or amine compounds. Moreover, the substance can be glycolyzed, hydrolyzed, oxidized, N-methylated, N-formylated, N-acetylated or comprise methyl, formyl, ethyl, acetyl, t-butyl, anisyl, benzyl, trifluoroacetyl, N-hydroxysuccinimide, t-butyloxycarbonyl, benzoyl, 4-methylbenzyl, thioanizyl, thiocresyl, benzyloxymethyl, 4-nitrophenyl, benzyloxycarbonyl, 2-nitrobenzoyl, 2-nitrophenylsulfenyl, 4-toluenesulfonyl, pentafluorophenyl, diphenylmethyl, 2-chlorobenzyloxycarbonyl, 2,4,5-trichlorophenyl, 2-bromobenzyloxycarbonyl, 9-fluorenylmethyloxycarbonyl, triphenylmethyl, 2,2,5,7,8-pentamethyl-chroman-6-sulfonyl. Likewise, a derivative is understood to mean the covalent or non-covalent bonding of the substance onto a macromolecular carrier, just as also a non-covalent inclusion in suitable macromolecular cage structures. Coupling with other macromolecular compounds, such as for example polyethylene glycol, can also be carried out. Further preferred chemical modifications for the substances that can be employed as the component (b) are the modification of one or more of the chemical groups —COOH, —OH, ═NH, —NH₂—SH to —COOR, —OR, —NHR, —NR2, —NHR, —NR, —SR; wherein:
R is —CH═CH—R2, —CEC-R2, —C(R2)═CH₂, —C(R2)═C(R3), —CH═NR2, —C(R2)═N—R3, a 4-7 carbon ring system with or without substitution, 4-7 nitrogen heterocycle with or without substitution, or a 2 to 8 carbon chain with 1 to 5 double or triple bonds with substitutions selected from R1, R2, or R3;
R1 is H, —R, —NO₂, —CN, -halo, —N₃, —C1-8 alkyl, —(CH₂)ₙCO₂R2, —C₂₋₈-alkenyl-CO₂R2, —O(CH₂)ₙCO₂R2, —C(O)NR2R3, —P(O)(OR2)₂, alkyl substituted tetrazol-5-yl, —(CH₂)ₙO(CH₂)ₙ aryl, —NR2R3, —(CH₂)ₙ OR2, —(CH₂)ₙSR2, —N(R2)C(O)R3, —S(O₂)NR2R3, —N(R2)S(O₂)R3, —(CHR2)ₙNR2R3, —C(O)R3, (CH₂)ₙN(R3)C(O)R3, —N(R2)CR2R3 substituted or unsubstituted (CH₂)ₙ-cycloalkyl, substituted or unsubstituted (CH₂)ₙ-phenyl, or ring;
—R2 is H, -halo, -alkyl, -haloalkyl, —(CH₂)ₙ-phenyl, —(CH₂)₁₋₃-biphenyl, —(CH₂)₁₋₄-Ph-N(SO₂—C₁₋₂-alkyl)₂, —CO(CHR1)ₙ—OR1, —(CHR1)ₙ-heterocycle, —(CHR1)ₙ—NH—CO—R1, —(CHR1)ₙ—NH—SO₂R1, —(CHR1)ₙ-Ph-N(SO₂—C₁₋₂-alkyl)₂, —(CHR1)ₙ—C(O)(CHR1)—NHR1, —(CHR1)ₙ—C(S)(CHR1)—NHR1, —(CH₂)ₙO(CH₂)ₙCH₃, —CF₃, —C₂₋₅ acyl, —(CHR1)ₙOH, —(CHR1)ₙCO₂R1, —(CHR1)ₙ—O-alkyl, —(CHR1)ₙ—O—(CH₂)ₙ—O-alkyl, —(CHR1)ₙ—S-alkyl, —(CHR1)ₙ—S(O)-alkyl, —(CHR1)ₙ—S(O₂)-alkyl, —(CHR1)ₙ—S(O₂)—NHR3, —(CHR3)ₙ—N₃, —(CHR3)ₙNHR4, 2 to 8 carbon atom alkene chain with 1 to 5 double bonds, 2 to 8 carbon alkyne chain with 1 to 5 triple bonds, substituted or unsubstituted —(CHR3)ₙ heterocycle, or substituted or unsubstituted saturated or unsaturated —(CHR3)ₙ cycloalkyl;
wherein n is greater than 1 and R1 and R3 can be the same or different;
—R3 is H, —OH, —CN, substituted alkyl, —C₂₋₈ alkenyl, substituted or unsubstituted cycloalkyl, —N(R1)R2, or 5-6 carbon saturated or unsaturated heterocycle. —NR2R3 can consist of a saturated or unsaturated heterocycle or a 4 to 7 atom heterocycle;
n is 0-4;
R4 and R5 each consists of: H, —(CH₂)ₙOH, —C(O)OR6, —C(O)SR6, —(CH₂)ₙC(O)NR7R8, —O—C(O)—O—R7, an amino acid or a peptide;
R6 is H,
R7 is, —C(R7)(R8)—(CH₂), —O—C(O)—R9, —(CH₂)ₙ—C(R7)(R8)—O—C(O)R9, —(CH₂)ₙ—C(R7)(R8)—O—C(O)—O—R9, or —C(R7)(R8)—(CH₂)ₙ—O—C(O)—O—R9; and
—R7, R8 and R9 each consist of H, alkyl, substituted alkyl, aryl, substituted aryl, alkenyl, substituted alkenyl, alkynyl, substituted alkynyl, heterocycle, substituted heterocycle, alkylaryl, substituted alkylaryl, cycloalkyl, substituted cycloalkyl, or CH₂CO₂alkyl.

It is also inventively possible to employ all possible combinations of the previously cited substances that belong to i., ii. or iii. and/or their derivatives in processes according to the invention.

The component (b) is preferably added to the washing agent or cleaning agent as a separate single substance, i.e. not as a component of an additional ingredient of the washing or cleaning agent. The component (b) is therefore preferably free in the washing or cleaning agent, i.e. it is dispersed in the agent and dispersed as homogeneously as possible. In the case of washing or cleaning agents in liquid or gel form, the component (b) is preferably dissolved or dispersed in the agent. The washing or cleaning agent particularly preferably comprises the component (b) not as a component of the presentation form of the hydrolytic enzyme (a), especially not as a component of an enzyme granulate.

Washing or cleaning agents in liquid or gel form are inventively preferred, i.e. not solid washing or cleaning agents.

A synergistic cleaning power of the component (b), which on interacting with the hydrolytic enzyme (a) when the agent is used, effects a synergistic cleaning power, is determined in a wash system that comprises a washing agent, dosed between 4.5 and 7.0 grams per liter wash liquor, as well as the hydrolytic enzyme (a) and the component (b) each singly or in combination, wherein each enzyme is added at equal activity, the component (b) is added in a concentration of 0.00025 to 0.6 wt. %, especially 0.0003 to 0.5 wt. % (added concentration in the wash liquor), and the washing power is determined for one or a plurality of the soils blood-milk/ink on cotton, whole egg/pigment on cotton, chocolate-milk/ink on cotton, peanut oil-pigment/ink on polyester/cotton, grass on cotton and cocoa on cotton, in particular for one or a plurality of the soils
Blood-milk/ink on cotton: product no. C5 from CFT B.V. Vlaardingen, Holland
Complete egg/pigment on cotton: product no. 10N obtainable from the company wflc Testgewebe GmbH; Brüggen-Bracht, Germany, cut up into small pieces.
Chocolate-milk/ink on cotton: product no. C3 from CFT B.V. Vlaardingen, Holland
Peanut oil-pigment/ink on polyester/cotton: product no. PC10 from CFT B.V. Vlaardingen, Holland
Grass on cotton, product no. 164 obtainable from the Company: Eidgenössische Material-und Prüfanstalt (EMPA) Testmaterialien AG, St. Gallen (Switzerland)
Cocoa on cotton, product no. 112 obtainable from the Company: Eidgenössische Material-und Prüfanstalt (EMPA) Testmaterialien AG, St. Gallen (Switzerland) by measuring the degree of whiteness of the washed fabrics, wherein the washing process lasts for at least 30 minutes, optionally 60 minutes, at a temperature of 20° C. and the water hardness of the water is between 15.5 and 16.5 (German hardness).

A preferred liquid washing agent for such a wash system is formulated as follows (all figures in weight percent): 0.3-0.5% Xanthane gum, 0.2-0.4% defoamer, 6-7% glycerine, 0.3-0.5% ethanol, 4-7% FAEOS (fatty alcohol ether sulfate), 24-28% non-ionic surfactants, 1% boric acid, 1-2% sodium citrate (dihydrate), 2-4% soda, 14-16% cocoanut fatty acids, 0.5% HEDP, 1-Hydroxyethane-(1,1-diphosphonic acid)), PVP, O-0.4% PVP (polyvinyl pyrrolidone) 0-0.5% optical brightener, 0-0.001% % colorant, residue demineralized water. The liquid washing agent is preferably dosed between 4.5 and 5.5 grams per liter of wash liquor, for example 4.9 grams per liter of wash liquor. The washing is preferably carried out in a pH range of between pH 8 and pH 10.5, preferably between pH 8 and pH 9.

A preferred powdered washing agent for such a wash system is formulated as follows (all figures in weight percent): 10% linear alkylbenzene sulfonate (sodium salt), 1.5% C12-C18 fatty alcohol sulfate (sodium salt), 2.0% C12-C18 fatty alcohol containing 7 EO, 20% sodium carbonate, 6.5% sodium hydrogen carbonate, 4.0% amorphous sodium disilicate, 17% sodium carbonate peroxyhydrate, 4.0% TAED, 3.0% polyacrylate, 1.0% carboxymethyl cellulose, 1.0% phosphonate, 25% sodium sulfate, residue: optional foam inhibitors, optical brightener, fragrances and optionally water to make up 100%. The liquid washing agent is preferably dosed between 6.0 and 7.0 grams per liter of wash liquor, for example 6.7 grams per liter of wash liquor. The washing is preferably carried out in a pH range of between pH 9 and pH 11.

A liquid washing agent is preferably used.

The whiteness degree, i.e. the brightening of the soils, is preferably determined with optical measurement methods, preferably photometrically. A suitable apparatus for this is the Minolta CM508d spectrometer, for example. The apparatuses used for the measurement are normally calibrated with a white standard, preferably with a white standard that was delivered with the apparatus.

The equal activity addition ensures that even for a possible divergence of the ratios of active substance to total protein (the value of the specific activity) each of the enzymatic properties, thus for example the washing power on certain soils, are compared. It is generally true that a low specific activity can be compensated by adding a larger amount of protein. Methods for determining the enzyme activities are known to the person skilled in the field of enzyme technology and are routinely used by him. Methods for measuring the protease activity, for example, are disclosed in Tenside, vol. 7 (1970), pp. 125-132. The protease activity is preferably given in PU (protease units). For example, suitable protease activities range from 5 to 10 PU (protease units) per ml of wash liquor. The added enzymatic activity is however not equal to zero.

The synergistic cleaning power is preferably based on a novel mechanism of action, i.e. no increase in the enzyme activity occurs in the classical sense, as would be measured—based on proteases—in one of the following processes. A synergism according to the invention therefore also then exists particularly when an improved cleaning power is observed in the presence of components (a) and (b) in comparison with the sum of the cleaning powers of the component (a) alone and the component (b) alone, and the component (b) in at least one of the following test methods, preferably in both of the following test methods, shows no effect in regard to the increase of the hydrolytic activity of the component (a), especially in regard to the increase of the hydrolytic activity of a protease, over and above the measurement-determined standard deviation:

Method 1: The protease activity was quantitatively determined using the liberation of the chromophore para-nitroaniline (pNA) from the substrate. The substrate is: suc-L-Ala-L-Ala-L-Pro-L-Phe-p-nitroanilide (substrate solution: 110 mM in DMSO). The protease cleaves the substrate and releases pNA. The released pNA causes the extinction at 410 nm to increase; the change in extinction as a function of time is a measure of the enzymatic activity (see DeI Mar et al., 1979).

The measurement is carried out at a temperature of 25° C., at pH 6 and a wavelength of 410 nm. The measurement period is 5 minutes with a measurement interval of 20s to 60s.

The buffer used (tris-HCl pH 8.6) was used as the blank sample. To each cuvette were added 10 μl of the substrate solution. 1000 μl buffer are added into a cuvette for each sample. 1-300 μl of the buffer and the component (b) (0.1, 0.2, 0.5 or 1 wt. % in buffer) were added into the cuvette. 1-300 μl of the protease and the blank sample were added into the cuvette. The measurement was begun on mixing the sample. After mixing, the cuvettes were immediately transferred into the photometer and the measurement was begun. An activation or stabilization of the protease can be quantified by means of the measurement data.

Method 2: The protease activity was determined from the hydrolysis of casein and the subsequent reaction of peptides soluble in TCA with Folin & Ciocalteu's phenol Reagent. The extinction of the resulting complex was measured at 660 nm and compared with a tyrosine standard Reaction mixtures comprise 3 ml of 0.8% (w/v) casein and 0.5 ml of a suitable enzyme dilution with or without the component (b) being tested (concentration 0.1, 0.2, 0.5 or 1 wt. %), both in universal buffer 1 from Britton and Robinson, pH 9.5 (see J. Chem. Soc. 1931, p. 1451). The mixtures were incubated at 25° C. for 30 minutes and the reaction was then interrupted by adding stop reagent (TCA). In control reactions the stop reagent was added prior to the addition of enzyme with or without the substance to be tested. After 20 minutes at 25° C. the reaction mixtures were then filtered through Whatman filter paper no. 42 or centrifuged.

Water, sodium carbonate and Folin & Ciocalteu's phenol Reagent were then added to the filtrate. After 30 minutes incubation the extinction was measured at 660 nm. An aliquoted portion of 200 μl of a tyrosine standard was measured in a similar way. The activity is expressed in protease units, wherein 1 PU is defined as the quantity of proteolytic enzyme that leads to the release of 1 mmol tyrosine, released per minute under defined conditions (cf. Anson, M. L., (1938) J. Gen. Physiol. 22, 79-89 and Folin, O., and Ciocalteu, V., (1929) J. Biol. Chem. 73, 627).

In another embodiment of the invention, the process is characterized in that the substances employed as the component (b) have a defined molecular weight. Accordingly, in another embodiment of the invention, the process is characterized in that the molecular weight (MW) of the component is from 150 to 5×106 Dalton, in particular from 200 to 1×106 Dalton, from 220 to 0.75×106 Dalton and especially from 400 to 0.5×106 Dalton. For substances with such molecular weights, there result particularly advantageous synergistic cleaning powers in the interaction with the hydrolytic enzyme (component (a)).

Advantageous synergistic cleaning powers also result when the substance employed as the component (b) is present in a defined concentration in the washing or cleaning agent. In another embodiment of the invention, the process is characterized in that this component is present in the agent in a concentration from 0.15 to 50 wt. %, in particular from 0.9 to 30 wt. %.

Concerning the added concentration, that is the concentration in the wash or cleaning liquor, there likewise results a particularly advantageous synergistic cleaning power when the substance employed as the component (b) is present in a defined concentration in the wash or cleaning liquor. Accordingly, in another embodiment of the invention, the process is characterized in that this component is present in a washing or cleaning liquor in a concentration of 0.00025 to 0.6 wt. %, in particular from 0.0003 to 0.5 wt. %.

The washing and cleaning agents employed in the process according to the invention include all possible types of washing and cleaning agents, both concentrates as well as agents to be used without dilution, for use on a commercial scale, in washing machines or in hand washing or cleaning. These include, for example, washing agents for fabrics, carpets or natural fibers, for which the term “washing agent” is used. These also include, for example, dishwasher detergents for dishwashing machines or manual dishwashing detergents or cleaners for hard surfaces, such as metal, glass, porcelain, ceramics, tiles, stone, painted surfaces, plastics, wood or leather, for which the term “cleaning agent” is used, therefore besides manual and automatic dishwasher detergents, for example also scouring agents, glass cleaners, WC-fragrant rinses, etc. In the context of the invention, the washing and cleaning agents further include washing auxiliaries that in the course of a manual or machine fabric wash are metered into the actual washing agent in order to achieve another effect. In the context of the invention, the washing and cleaning agents also include fabric pre- and after-conditioners, i.e. those materials that are brought into contact with the washing, for example in order to partially dissolve intractable soils, and also those materials that in a step that follows on from the actual fabric wash, confer additional desirable properties to the washing, such as a pleasant touch, absence of creasing or a low residual static charge. The last mentioned agents include inter alia the fabric softeners.

The washing and cleaning agents that can be used in the inventive process can be present especially as powdery solids, in the form of post-compacted particles, as homogeneous solutions or suspensions, and can comprise in principle all known and customary ingredients for such agents in addition to the inventively used active substances—the components (a) and (b), wherein at least one additional ingredient is present in the agent. In particular, the agents can comprise builders, surface-active surfactants, bleaching agents based on organic and/or inorganic peroxy compounds, bleach activators, water-miscible organic solvents, enzymes, sequestrants, electrolytes, pH regulators and further auxiliaries such as optical brighteners, graying inhibitors, foam regulators as well as colorants and fragrances as well as combinations thereof. In particular, a further combination of the active substances according to the invention with one or more additional ingredient(s) of the agent proves to be advantageous, as then an additionally improved cleaning power can be achieved through additional resulting synergisms. An additional synergism is achieved in particular by the combination with a surfactant and/or a builder and/or a bleaching agent. Such preferred additional ingredients of the washing or cleaning agent are disclosed in the international application WO 2009/021867, the disclosure of which is therefore explicitly referred to or the disclosure of which is therefore expressly incorporated into the present application.

The available choices for ingredients and also the conditions, under which the agent is used, such as, for example temperature, pH, ion strength, redox conditions or mechanical influences, should be optimized for each cleaning problem. Thus, usual temperatures for washing and cleaning agents are in the range 10° C. to over 40° C. and 60° C. up to 95° C. for machine compositions or for industrial applications. Preferably, the ingredients of the agent in question are harmonized with each other, in particular such that synergies result in regard to the cleaning power. Particularly preferred synergies are present in a temperature range between 10° C. and 60° C., especially in a temperature range of 10° C. to 50° C., from 10° C. to 40° C., from 10° C. to 30° C., from 10° C. to 25° C., from 15° C. to 25° C. and quite particularly preferably at 20° C.

In another preferred embodiment, an agent that is employed in inventive processes further comprises the hydrolytic enzyme in an amount of 2 μg to 20 mg, preferably from 5 μg to 17.5 mg, particularly preferably from 20 μg to 15 mg and quite particularly preferably from 50 μg to 10 mg per gram of the agent. Furthermore, the hydrolytic enzyme comprised in the agent, especially a protease, and/or additional ingredients of the agent, can be encapsulated with a substance that is impermeable to the enzyme at room temperature or in the absence of water, and which becomes permeable to the enzyme under the conditions of use of the agent. Such an embodiment of the invention is therefore characterized in that the hydrolytic enzyme is encapsulated with a substance that is impermeable to the enzyme at room temperature or in the absence of water. In addition, the washing or cleaning agent itself can also be packaged in a container, preferably an air-permeable container, from which it is released shortly before use or during the washing process.

In further embodiments of the invention, the process is characterized in that the washing or cleaning agent

(a) is in solid form, especially as a free-flowing powder with a bulk density of 300 g/l to 1200 g/l, especially 500 g/l to 900 g/l, or
(b) is in a pasty or in liquid form, and/or
(c) exists as a one-component system, or
(d) is subdivided into a plurality of components.

These embodiments of the present invention further include all solid, powdery, liquid, gelified or pasty presentation forms of the agents that can be employed in the process according to the invention, and can optionally consist of a plurality of phases as well as being in a compressed on non-compressed form. The agent can exist as a free-flowing powder, especially with a bulk density of 300 g/l to 1200 g/l, especially 500 g/l to 900 g/l or 600 g/l to 850 g/l. The solid presentation forms of the agent further include extrudates, granulates, tablets or pouches. Alternatively, the agent can also be in the form of a liquid, gel or paste, for example in the form of a non-aqueous liquid washing agent or a non-aqueous paste or in the form of an aqueous liquid washing agent or a water-containing paste. In addition, the agent can be a one-component system. Such agents preferably consist of one phase. Alternatively, an agent can also consist of a plurality of phases. An agent of this type is consequently separated into a plurality of components.

Washing or cleaning agents that can be employed in the inventive process can comprise exclusively a hydrolytic enzyme, for example and especially a protease. Alternatively however, they can also comprise additional hydrolytic enzymes or other enzymes in an appropriate concentration for the activity of the agent, wherein all enzymes established in the prior art for these purposes can be employed. All enzymes that can develop a catalytic activity in the agent can preferably be employed as the additional enzymes, in particular proteases, amylases, cellulases, hemicellulases, mannanases, tannases, xylanases, xanthanases, β-glucosidases, carrageenases, oxidases, perhydrolases, oxidoreductases or lipases, preferably also their mixtures. In principle, these enzymes are of natural origin; improved variants based on the natural molecules are available for use in laundry detergents and cleaning agents and accordingly they are preferred.

Another subject matter of the invention is a washing or cleaning process comprising the process steps

(a) preparing a washing or cleaning solution comprising a washing or cleaning agent that
i. comprises a hydrolytic enzyme, in particular a protease, amylase, cellulase, hemicellulase, mannanase, tannase, xylanase, xanthanase, β-glucosidase, carrageenase or a lipase, particularly preferably a protease, and
ii. comprises a component that in interacting with the hydrolytic enzyme when the agent is used, effects a synergistic cleaning power, and which is selected from
   1. an anionic and/or polyanionic substance, and/or
   2. a cationic and/or polycationic substance, and/or
   3. a substance that possesses hydroxyl and/or polyhydroxyl group(s);
      (b) contacting a textile or a hard surface with the washing or cleaning solution according to (a).

All facts, subjects and embodiments, which have been described above for all the inventive processes, are also applicable to this subject matter of the invention. Therefore, reference is hereby explicitly made to the disclosure at the appropriate location with the remark that this disclosure is also valid for this subject matter of the invention.

A process of this kind is advantageous, because as previously described, the cleaning power of a washing or cleaning agent that comprises an appropriate hydrolytic enzyme, is improved by the addition of a component as specified. Consequently, the process advantageously eliminates corresponding contamination, especially protein-containing contamination, from fabrics or from hard surfaces. Washing by hand, the manual removal of stains from fabrics or from hard surfaces or the use in connection with an automatic process are exemplary embodiments of this subject matter of the invention.

Processes for the cleaning of fabrics are generally characterized in that various cleaning-active substances are applied to the material to be cleaned in a plurality of process steps and, after the contact time, are washed away, or that the material to be cleaned is treated in any other way with a washing agent or a solution of this agent. The same applies to processes for cleaning hard surfaces.

As a hydrolytic enzyme, i.e. component (a), already naturally possesses a hydrolytic activity and also develops this in media that otherwise do not have any cleaning power, such as for example in a pure buffer, then such a process can consist solely of applying, in addition to the added component (b), a hydrolytic enzyme as the single additional component, i.e. component (a), preferably in a buffer solution or in water. This represents another embodiment of the subject matter of this invention.

All processes according to the invention are preferably carried out in a temperature range from 0° C. to 35° C., in particular from 5° C. to 32° C. and particularly preferably in a temperature range from 10° C. to 30° C. A synergistic interaction of the components (a) and (b) in regard to the cleaning power exists in particular at these lower to medium wash temperatures or cleaning temperatures.

Another subject matter of the invention is the use of a component that is selected from
i. an anionic and/or polyanionic substance, and/or
ii. a cationic and/or polycationic substance, and/or
iii. a substance that possesses hydroxyl and/or polyhydroxyl group(s),

in order to achieve a synergistic cleaning power in the interaction with a hydrolytic enzyme in a washing or cleaning agent when using the washing or cleaning agent, in particular in the interaction with a protease, amylase, cellulase, hemicellulase, mannanase, tannase, xylanase, xanthanase, β-glucosidase, carrageenase or a lipase, particularly preferably in the interaction with a protease.

The facts, subjects and embodiments, which have been described for the inventive processes, are also applicable to this subject matter of the invention. Therefore, reference is hereby explicitly made to the disclosure at the appropriate location with the remark that this disclosure is also valid for the preceding use according to the invention.

Therefore, in another embodiment, the use is characterized in that the component is present in the agent in a concentration from 0.15 to 50 wt. %, in particular from 0.9 to 30 wt. %.

Another subject matter of the invention is the use of a component that is selected from
i. an anionic and/or polyanionic substance, and/or
ii. a cationic and/or polycationic substance, and/or
iii. a substance that possesses hydroxyl and/or polyhydroxyl group(s),

in order to increase the cleaning power of a hydrolytic enzyme in a washing or cleaning process.

As previously described, this component (component (b)) interacts advantageously, in particular synergistically, with a hydrolytic enzyme (component (a)), such that not only the cleaning power of a washing or cleaning agent (or the wash liquor formed from this agent) is improved, but also the cleaning power of the hydrolytic enzyme itself. The facts, subjects and embodiments, which have been described for the inventive washing or cleaning processes, are also applicable to this subject matter of the invention. Therefore, reference is hereby explicitly made to the disclosure at the appropriate location with the remark that this disclosure is also valid for the preceding use according to the invention.

Preferred embodiments of the use according to the invention are further characterized in that the substances employed as the component (b) have a defined molecular weight. Accordingly, in preferred embodiments of the invention, a use according to the invention is characterized in that the molecular weight (MW) of this component is from 150 to 5×106 Dalton, in particular from 200 to 1×106 Dalton, from 220 to 0.75×106 Dalton and especially from 400 to 0.5×106 Dalton.

### Example 1

### The Framework Formulation Listed Below (cf. Table 2) for a Washing Agent for Fabrics was Used for the Determination of the Cleaning Power

TABLE 2

| Ingredient | Wt. % pure substance |
|---|---|
| Xanthan | 0.3-0.5 |
| Defoamer | 0.2-0.4 |
| Glycerine | 6-7 |
| Ethanol | 0.3-0.5 |
| FAEOS | 4-7 |
| Non-ionic surfactants (FAEO, APG, i.a.) | 24-28 |
| Boric acid | 1 |
| Sodium citrate (dihydrate) | 1-2 |
| Soda | 2-4 |
| Coconut fatty acid | 14-16 |
| HEDP | 0.5 |
| PVP | 0-0.4 |
| Optical brightener | 0-0.05 |
| Colorant | 0-0.001 |
| Perfume | 0-2 |
| H₂O, demineralized | remainder |

The test preparations were each formulated in 24 well plates in 1 ml wash liquor as shown below in Table 3. The incubation was carried out at 20° C. for 60 minutes with shaking (ca. 100 rpm).

TABLE 3

| Volumes | Solution |
|---|---|
| 420 μl | 161-196 mg fabric washing |
| | agent in 42 ml water or buffer |
| 30-530 μl | 1-100 PU/ml protease |
| 30-530 μl | Pre-prepared substance solution |
| remainder | H₂O |
| | Soil Ø ca. 1 cm |

Circular pieces of soils (diameter ca. 10 mm) were used, selected from the following soils:
Blood-milk/ink on cotton: product no. C5 from CFT B.V. Vlaardingen, Holland
Whole egg/pigment on cotton: product no. 10N obtainable from the company wfk Testgewebe GmbH; Brüggen-Bracht, Germany,
Chocolate-milk/ink on cotton: product no. C3 from CFT B.V. Vlaardingen, Holland
Peanut oil-pigment/ink on polyester/cotton: product no. PC10 from CFT B.V. Vlaardingen, Holland
Grass on cotton: product no. 164 obtainable from the Company Eidgenössische Material-und Prüfanstalt (EMPA) Testmaterialien AG, St. Gallen, Switzerland
Cocoa on cotton, product no. 112 obtainable from the Company Eidgenössische Material-und Prüfanstalt (EMPA) Testmaterialien AG, St. Gallen (Switzerland)

After the incubation, the soils were rinsed three times, dried and fixed and the degree of whiteness of the washed fabrics was measured in comparison with a whiteness standard (d/8, ø8 mm, SCl/SCE), which had been set to 100% (L-value determination). The measurement was made using a colorimeter (Minolta Cm508d) with a light setting of 107D65.

The proteases used were the alkaline protease from Bacillus lentus DSM 5483 (WO 92/21760, hereinafter called Protease 1) as well as the protease, disclosed in FIG. 2 and SEQ ID NO. 3 of the international application WO 03/057713 (hereinafter called Protease 2).

### Example 2

### The Washing Power was Tested with the Following Substances (Component (b))

Acusol 590 (polyacrylate copolymer, Rohm & Haas/Dow Chemical)
Sokalan PA 30CL (polycarboxylate sodium salt, BASF)
Poly-2-acrylamido-2-methyl-1-propane sulfonic acid
Poly-4-styrene sulfonic acid-co-maleic acid sodium salt
Poly-acrylamido-co-acrylic acid sodium salt
Polymethacrylic acid sodium salt
Polyvinyl sulfonic acid sodium salt
Polyacrylate sodium salt

Stock solutions with these substances were made up with 0.00001-1.5 M substance or 0.0001-55% (weight or volume) in water or buffer (phosphate 0.00001-1.5 M pH 6.5-8.0 or Tris 0.00001-1.5 M pH 7.5-9.0 or Soerensen buffer pH 7.5-9.0 or citrate buffer 0.00001-1.5 M pH 4.5-7.0 or acetate buffer 0.00001-1.5 M pH 2.5-5.5).

The cleaning powers obtained for each of the listed test preparations are shown in the Tables 4 and 5 below. The obtained results are the sum of the improvements for all six listed soils and are expressed as the percentage power, wherein each value was formed from each of the differences of the reflectance values of the tested washing agent minus the control (washing agent without enzyme and without substance). The increase in power of the washing agent with hydrolytic enzyme (here with protease), but without power increasing substance, over the washing agent without hydrolytic enzyme (protease) and substance was set to 100% as the reference. Therefore, 100% represents the cleaning power of the washing agent with hydrolytic enzyme (protease) alone, i.e. without power increasing substance. In contrast, values greater than 100% therefore show an increased cleaning power over this reference and values less than 100% show a decreased cleaning power over this reference. The values lower than 100% listed as “without enzyme” in the tables therefore mean that a washing agent containing the relevant substance, but not the hydrolytic enzyme, has indeed a somewhat better cleaning power than the control, but by far does not come up to the cleaning power of the reference washing agent (with hydrolytic enzyme, without substance), and is far below the cleaning power of a washing agent with hydrolytic enzyme and power-increasing substance.

It is apparent that the added components (b) cause a synergistic increase of the washing power for those washing agents that comprise a hydrolytic enzyme, namely a protease, i.e. component (a). In controls that do not comprise any hydrolytic enzyme, these components (b) do not cause any synergistic increase in the washing power, such that the increased washing power is based on an advantageous, synergistic interaction of the components (a) and (b).

TABLE 4
Washing test at 20° C. with protease 1

| | 8% in | 4% in | 8% |
|---|---|---|---|
| | washing | washing | without |
| Substance | agent | agent | enzyme |
| Acusol 590 | 153.6% | 150.0% | 18% |
| Sokalan PA 30CL | 182.1% | 167.9% | 43% |
| Polyacrylate sodium salt | 157.1% | 142.9% | 21% |
| Polymethacrylic acid sodium salt | 175.0% | 150.0% | 36% |
| Polyacrylamido-co-acrylic acid sodium salt | 150.0% | 139.3% | 25% |
| Polyvinyl sulfonic acid sodium salt | 160.7% | 125.0% | 21% |
| Poly-4-styrene sulfonic acid-co-maleic acid | 142.9% | 132.1% | 11% |
| sodium salt | | | |
| Poly-2-acrylamido-2-methyl-1-propane | 146.4% | 132.1% | 18% |
| sulfonic acid | | | |

TABLE 5
Washing test at 20° C. with protease 2

| | 8% in | 4% in | 8% |
|---|---|---|---|
| | washing | washing | without |
| Substance | agent | agent | enzyme |
| Polyacrylate sodium salt | 138% | 119% | 23% |
| Polyvinyl sulfonic acid sodium salt | 135% | 115% | 23% |

Advantageous increases in the cleaning power of an agent with protease as the hydrolytic enzyme were again obtained in a similar manner by using the compounds Acusol 587D, Acusol 916, Sokalan CP42, alginic acid or polymethyl vinyl ether-alt maleic acid as the component (b).

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A process for improving the cleaning power of a washing or cleaning agent, the method comprising:
providing a washing or cleaning agent comprising a hydrolytic enzyme; and
adding a component to the washing or cleaning agent which, by interacting with the hydrolytic enzyme when the agent is used, affects a synergistic cleaning power, the component being one or more substance selected from the group consisting of:
i. an anionic and/or polyanionic substance,
ii. a cationic and/or polycationic substance, and
iii. a substance that possesses hydroxyl and/or polyhydroxyl group(s).

2. The process according to claim 1, wherein the hydrolytic enzyme provided in the washing or cleaning agent is one or more enzymes selected from the group consisting of a protease, amylase, cellulase, hemicellulase, mannanase, tannase, xylanase, xanthanase, β-glucosidase, carrageenase or a lipase.

3. The process according to claim 2, wherein the hydrolytic enzyme provided in the washing or cleaning agent is a protease.

4. The process according to claim 1, wherein the molecular weight (MW) of the component is from 150 to 5×106 Dalton, in particular from 200 to 1×106 Dalton, from 220 to 0.75×106 Dalton and especially from 400 to 0.5×106 Dalton.

5. The process according to claim 1, wherein the component is present in the agent in a concentration from 0.15 to 50 wt. %, in particular from 0.9 to 30 wt. %.

6. The process according to claim 1, wherein the component is present in a washing or cleaning liquor in a concentration of 0.00025 to 0.6 wt. %, in particular from 0.0003 to 0.5 wt. %.

7. The process according to claim 1, wherein the washing or cleaning agent comprises the hydrolytic enzyme in an amount from 2 μg to 20 mg, preferably from 5 μg to 17.5 mg, particularly preferably from 20 μg to 15 mg, quite particularly preferably from 50 μg to 10 mg per g of the agent, and/or wherein the hydrolytic enzyme in the washing or cleaning agent is encapsulated with a substance that is impermeable to the enzyme at room temperature or in the absence of water.

8. The process according to one of claim 1, wherein the washing or cleaning agent is in a form selected from the group consisting of:
(a) solid form, as a free-flowing powder with a bulk density of 300 g/l to 1200 g/l, especially 500 g/l to 900 g/l,
(b) a paste form,
(c) a liquid form,
(d) a one-component system, or
(d) subdivided into a plurality of components.

9. A washing or cleaning process comprising:
(a) preparing a washing or cleaning solution comprising a washing or cleaning agent comprising:
i. a hydrolytic enzyme, and
ii. a component that, by interacting with the hydrolytic enzyme when the agent is used, affects a synergistic cleaning power, and which is selected from the group consisting of:
1. an anionic and/or polyanionic substance,
2. a cationic and/or polycationic substance, and
3. a substance that possesses hydroxyl and/or polyhydroxyl group(s); and
(b) contacting a textile or a hard surface with the washing or cleaning solution.

10. The process according to claim 9, wherein the hydrolytic enzyme provided in the washing or cleaning agent is one or more enzymes selected from the group consisting of a protease, amylase, cellulase, hemicellulase, mannanase, tannase, xylanase, xanthanase, β-glucosidase, carrageenase or a lipase.

11. The process according to claim 10, wherein the hydrolytic enzyme provided in the washing or cleaning agent is a protease.

12. The process according to claim 9, wherein said process is carried out in a temperature range from 0° C. to 35° C., in particular from 5° C. to 32° C.

13. The process according to claim 12, wherein said process is carried out in a temperature range from 10° C. to 30° C.
